(19) United States
(12) Patent Application Publication
(10) Pub. No.: US 2013/0028478 A1
(43) Pub. Date: Jan. 31, 2013

(54) OBJECT INSPECTION WITH REFERENCED VOLUMETRIC ANALYSIS SENSOR

(71) Applicants: Éric St-Pierre, Levis (CA); Patrick Hébert, Quebec (CA); Charles Mony, Quebec (CA)

(72) Inventors: Éric St-Pierre, Levis (CA); Patrick Hébert, Quebec (CA); Charles Mony, Quebec (CA)

(21) Appl. No.: 13/639,359

(22) PCT Filed: May 3, 2011
(86) PCT No.: PCT/IB2011/051959

§ 371 Date: Oct. 4, 2012

Related U.S. Application Data
(60) Provisional application No. 61/331,058, filed on May 4, 2010.

(51) Int. Cl. G06K 9/00

(52) U.S. Cl. 382/103; 382/106

(57) ABSTRACT

A positioning method and system for non-destructive inspection of an object include providing at least one volumetric analysis sensor having sensor reference targets; providing a sensor model of a pattern of at least some of the sensor reference targets; providing object reference targets on at least one of the object and an environment of the object; providing an object model of a pattern of at least some of the object reference targets; providing a photogrammetric system including at least one camera and capturing at least one image in a field of view, at least a portion of the sensor reference and the object reference targets being apparent on the image; determining a sensor spatial relationship and an object spatial relationship; determining a sensor-to-object spatial relationship of the at I act one volumetric analysis sensor with respect to the object; repeating the steps and tracking a displacement of the volumetric analysis sensor and the object.

### CROSS-REFERENCE TO RELATED APPLICATIONS

This application claims priority of U.S. provisional patent application No. 61/331,058 filed May 4, 2010 by Applicant, the specification of which is hereby incorporated by reference.

### TECHNICAL FIELD

The present description generally relates to the field of quantitative non destructive evaluation and testing for the inspection of objects with volumetric analysis sensors.

### BACKGROUND OF THE ART

Non destructive testing (NDT) and quantitative non destructive evaluation (NDE) have significantly evolved in the past 20 years, especially in the new sensing systems and the procedures that have been specifically developed for object inspection. The defence and nuclear power industries have played a major role in the emergence of NDT and NDE. Increasing global competition in product development as seen in the automotive industry has also played a significant role. At the same time, aging infrastructures, such as roads, bridges, railroads or power plants, present a new set of measurement and monitoring challenges.

Measurement systems have been improved and new systems have been developed for subsurface or more generally, volumetric measurements. These systems have various sensor modalities such as x-ray, infrared thermography, Eddy current and ultrasound which are examples of modalities for internal volume measurement of characteristics or flaws. Moreover, three-dimensional non-contact range scanners have also been developed over the last decades. Range scanners of that type make it possible to inspect the external surface of an object to assess its conformity with a reference model or to characterize some flaws.

Among more recent advances, the development of compact sensors that can simultaneously gather a set of several measurements over an object's section is highly significant. In order to automatically register the whole sets of measurements in a common coordinate system, these sensors have been mounted on a robotic mechanical arm or automated system that provides the position and orientation of the system. Even after solving accuracy issues, the objects must still be inspected within a fixed industrial or laboratory environment. One of the current challenges of the industry is to make referenced inspection systems portable in order to proceed to onsite object inspection.

Portable ultrasound systems have been developed for several industries such as oil & gas, aerospace and power generation among others. For instance, in the oil & gas industry the inspection of pipes, welds, pipelines, above ground storage tanks, and many other objects is systematically applied. These objects are typically submitted to NDE to detect various features such as the thickness of their surface material. Typically, an ultrasound transducer (probe) is connected to a diagnosis machine and is passed over the object being inspected. For example, inspecting a corroded pipe will require collecting several thickness measurements at multiple sensor positions over the object.

The first problem that has to be addressed with these portable ultrasound systems is the integration of measurements gathered at different sensor positions, in a common coordinate system. A wheel with an integrated encoder mounted on an ultrasound sensor allows one to measure the relative displacement over short distances. Using such an apparatus, it is possible to collect and localize thickness measurements along the surface of a pipe. This type of system only measures a relative displacement along an axis and imposes an uninterrupted contact between the object and the wheel. Moreover, any sliding will affect the estimated displacement. A mechanical fixture can be used to acquire the probe position along two axes to perform a raster scan and thus obtain a 2D parameterization of the measurements on the object surface. Fixing the scanner to the inspected object presents a challenge in terms of ergonomy, versatility and usability. These limitations can be circumvented by using a mechanical arm with encoders; this device measures the 6 degrees of freedom (6 DOF) between the device mounted at its extremity and its own global reference set relative to its basis. Beforehand, one must calibrate the spatial relationship between the coordinate system of the ultrasound sensor and that of the extremity of the arm. This type of positioning device makes it possible to move the ultrasound probe arbitrarily over a working volume. Moreover, this type of positioning device is transportable.

Although resolution and accuracy of these portable ultrasound systems are acceptable for most applications, one limitation is the size of the spherical working volume, generally less than 2 to 4 m in diameter, which is imposed by the length of the mechanical arm. One can apply leapfrogging to extend the volume. Using a mechanical touch probe at the extremity of the arm, one must probe physical features such as corners or spheres to define a temporary local object coordinate system that will be measurable (observable) from the next position of the mechanical arm. After completing these measurements with the touch probe, one then displaces the mechanical arm to its new position that will make it possible to reach new sections of the object and then installs the arm in its new position. In the next step, from the new position, one will again probe the same physical features and calculate the spatial relationship between these features defining a local coordinate system and the new position of the arm's basis. Finally, chaining the transformation defining this new spatial relationship to the former transformation between the previously probed features and the former position of the arm's basis, it is possible to transform all measured data from one coordinate system to the other. Since this operation imposes an additional manual procedure that can reduce overall accuracy, leapfrogging should be minimized as much as possible.

Moreover, using a mechanical arm is relatively cumbersome. For larger working volumes, a position tracker can be used in industrial settings or an improved tracker could provide both the position and orientation of the sensor with 6 DOF. This type of system device is expensive and sensitive to beam occlusion when tracking. Moreover, it is also common that objects to be measured are fixed and hardly accessible. Pipes installed at a high position above the floor in cluttered environments are difficult to access. Constraints on the position of the positioning device may impose to mount the device on elevated structures that are unstable considering the level of accuracy that is sought.

There is therefore a need to measure 6 DOF in an extended working volume that could reach several meters while taking into account the relative motion between the origin of the positioning device, the object to be measured and the volumetric analysis sensor. One cannot continue to consider the relative position between the positioning device and the object to be constant.

Thus, besides positioning the volumetric analysis sensor, the second challenge that has to be addressed is obtaining a reference of the volumetric analysis sensor measurements with respect to the external object's surface. Although it is advantageous to transform all measurements in a common coordinate system, several applications such as pipe corrosion analysis will impose to measure the geometry of the external surface as a reference. Currently, considering the example of an ultrasound sensor, one can measure the material thickness for a given position and orientation of the sensor. However, one cannot determine whether surface erosion affects more the internal surface compared with the external surface, and more precisely in what proportion.

The same problem of using a continuous reference that is accurate arises with other volumetric analysis sensor modalities such as infrared thermography for instance. This latter modality could also provide information for a volumetric analysis of the material, yet at a lower resolution. X-ray is another modality for volumetric analysis.

### SUMMARY

It is an object of the present invention to address at least one shortcoming of the prior art.

According to one broad aspect of the present invention, there is provided a positioning method and system for non-destructive inspection of an object. The method comprises providing at least one volumetric analysis sensor having sensor reference targets; providing a sensor model of a pattern of at least some of the sensor reference targets; providing object reference targets on at least one of the object and an environment of the object; providing an object model of a pattern of at least some of the object reference targets; providing a photogrammetric system including at least one camera and capturing at least one image in a field of view, at least a portion of the sensor reference targets and the object reference targets being apparent on the image; determining a sensor spatial relationship; determining an object spatial relationship; determining a sensor-to-object spatial relationship of the at least one volumetric analysis sensor with respect to the object using the object spatial relationship and the sensor spatial relationship; repeating the steps and tracking a displacement of the at least one of the volumetric analysis sensor and the object using the sensor-to-object spatial relationship.

According to another broad aspect of the present invention, there is provided a positioning method for non-destructive inspection of an object, comprising: providing at least one volumetric analysis sensor for the inspection; providing sensor reference targets on the at least one volumetric analysis sensor; providing a photogrammetric system including at least one camera to capture images in a field of view; providing a sensor model of a pattern of 3D positions of at least some of the sensor reference targets of the volumetric analysis sensor; determining a sensor spatial relationship, in a global coordinate system, between the photogrammetric system and the sensor reference targets using the sensor model and the images; tracking a displacement of the volumetric analysis sensor in the global coordinate system, using the photogrammetric system, the images and the sensor model of the pattern.

According to another broad aspect of the present invention, there is provided a positioning system for non-destructive inspection of an object, comprising: at least one volumetric analysis sensor for the inspection; sensor reference targets provided on the at least one volumetric analysis sensor; a photogrammetric system including at least one camera to capture images in a field of view; a position tracker for obtaining a sensor model of a pattern of 3D positions of at least some of the sensor reference targets of the volumetric analysis sensor; determining a sensor spatial relationship between the photogrammetric system and the sensor reference targets using the sensor model in a global coordinate system; tracking a displacement of the volumetric analysis sensor using the photogrammetric system and the sensor model of the pattern in the global coordinate system.

According to another broad aspect of the present invention, there is provided a positioning method for non-destructive inspection of an object. The method comprises providing at least one volumetric analysis sensor for the inspection, the volumetric analysis sensor having sensor reference targets; providing a sensor model of a pattern of 3D positions of at least some of the sensor reference targets of the volumetric analysis sensor; providing object reference targets on at least one of the object and an environment of the object; providing an object model of a pattern of 3D positions of at least some of the object reference targets; providing a photogrammetric system including at least one camera to capture at least one image in a field of view; capturing an image in the field of view using the photogrammetric system, at least a portion of the sensor reference targets and the object reference targets being apparent on the image; determining a sensor spatial relationship between the photogrammetric system and the sensor reference targets using the sensor model and the captured image; determining an object spatial relationship between the photogrammetric system and the object reference targets using the object model and the captured image; determining a sensor-to-object spatial relationship of the at least one volumetric analysis sensor with respect to the object using the object spatial relationship and the sensor spatial relationship; repeating the capturing, the determining the sensor-to-object spatial relationship and at least one of the determining the sensor spatial relationship and the determining the object spatial relationship; tracking a displacement of the at least one of the volumetric analysis sensor and the object using the sensor-to-object spatial relationship.

In one embodiment, the method further comprises providing inspection measurements about the object using the at least one volumetric analysis sensor; and using at least one of the sensor spatial relationship, the object spatial relationship and the sensor-to-object spatial relationship to reference the inspection measurements and generate referenced inspection data in a common coordinate system.

In one embodiment, at least one of the providing the object model and providing the sensor model includes building a respective one of the object and sensor model during the capturing the image using the photogrammetric system.

In one embodiment, the method further comprises providing an additional sensor tool; obtaining sensor information using the additional sensor tool; referencing the additional sensor tool with respect to the object.

In one embodiment, the referencing the additional sensor tool with respect to the object includes using an independent positioning system for the additional sensor tool and using the object reference targets.

In one embodiment, wherein the additional sensor tool has tool reference targets; and the method further comprises providing a tool model of a pattern of 3D positions of at least some of the tool reference targets of the additional sensor tool; determining a tool spatial relationship between the photogrammetric system and the tool reference targets using the tool model; determining a tool-to-object spatial relationship of the additional sensor tool with respect to the object using the tool spatial relationship and at least one of the sensor-to-object spatial relationship and the object spatial relationship; repeating the capturing, the determining the tool spatial relationship and the determining the tool-to-object spatial relationship; tracking a displacement of the additional sensor tool using the tool-to-object spatial relationship.

In one embodiment, the method further comprises building a model of an internal surface of the object using the inspection measurements obtained by the volumetric analysis sensor.

In one embodiment, the inspection measurements are thickness data.

In one embodiment, the method further comprises providing a CAD model of an external surface of the object; using the CAD model and the sensor-to-object spatial relationship to align the inspection measurements obtained by the volumetric analysis sensor in the common coordinate system.

In one embodiment, the method further comprises providing a CAD model of an external surface of the object; acquiring information about features of the external surface of the object using the additional sensor tool; using the CAD model, the information about features and the sensor-to-object spatial relationship to align the inspection measurements obtained by the volumetric analysis sensor in the common coordinate system.

In one embodiment, the method further comprises comparing the CAD model to the referenced inspection data to identify anomalies in the external surface of the object.

In one embodiment, the method further comprises requesting an operator confirmation to authorize recognition of a reference target by the photogrammetric system.

In one embodiment, the method further comprises providing an inspection report for the inspection of the object using the referenced inspection measurements.

In one embodiment, the displacement is caused by uncontrolled motion.

In one embodiment, the displacement is caused by environmental vibrations.

In one embodiment, the photogrammetric system is displaced to observe the object within another field of view, the steps of capturing an image, determining a sensor spatial relationship, determining an object spatial relationship, determining an sensor-to-object relationship are repeated.

According to another broad aspect of the present invention, there is provided a positioning system for non-destructive inspection of an object. The system comprises at least one volumetric analysis sensor for the inspection, the volumetric analysis sensor having sensor reference targets and being adapted to be displaced; object reference targets provided on at least one of the object and an environment of the object; a photogrammetric system including at least one camera to capture at least one image in a field of view, at least a portion of the sensor reference targets and the object reference targets being apparent on the image; a position tracker for obtaining a sensor model of a pattern of 3D positions of at least some of the sensor reference targets of the volumetric analysis sensor; obtaining an object model of a pattern of 3D positions of at least some of the object reference targets; determining an object spatial relationship between the photogrammetric system and the object reference targets using the object model pattern and the captured image; determining a sensor spatial relationship between the photogrammetric system and the sensor reference targets using the sensor model and the captured image; determining a sensor-to-object spatial relationship of the at least one volumetric analysis sensor with respect to the object using the object spatial relationship and the sensor spatial relationship; tracking a displacement of the volumetric analysis sensor using sensor-to-object spatial relationship.

In one embodiment, the volumetric analysis sensor provides inspection measurements about the object and wherein the position tracker is further for using at least one of the sensor spatial relationship, object spatial relationship and sensor-to-object spatial relationship to reference the inspection measurements and generate referenced inspection data.

In one embodiment, the system further comprises a model builder for building at least one of the sensor model and the object model using the photogrammetric system.

In one embodiment, the system further comprises an additional sensor tool for obtaining sensor information.

In one embodiment, the additional sensor tool is adapted to be displaced and the additional sensor tool has tool reference targets and wherein the position tracker is further for tracking a displacement of the additional sensor tool using the photogrammetric system and a tool model of a pattern of tool reference targets on the additional sensor tool.

In one embodiment, the additional sensor tool is at least one of a 3D range scanner and a touch probe.

In one embodiment, the reference targets are at least one of coded reference targets and retro-reflective targets.

In one embodiment, the system further comprises an operator interface for requesting an operator confirmation to authorize recognition of a target by the photogrammetric system.

In one embodiment, the system further comprises a CAD interface, the CAD interface receiving a CAD model of an external surface of the object and comparing the CAD model to the referenced inspection data to align the model.

In one embodiment, the system further comprises a report generator for providing an inspection report for the inspection of the object using the referenced inspection measurements.

In one embodiment, the photogrammetric system has two cameras with a light source for each of the two cameras, each the light source providing light in the field of view in a direction co-axial to a line of sight of the camera.

In one embodiment, the volumetric analysis sensor is at least one of a thickness sensor, an ultrasound probe, an infrared sensor and an x-ray sensor.

In the present specification, the term “volumetric analysis sensor” is intended to mean a non-destructive testing sensor or non-destructive evaluation sensor used for non-destructive inspection of volumes, including various modalities such as x-ray, infrared thermography, ultrasound, Eddy current, etc.

In the present specification, the term “sensor tool” or “additional sensor tool” is intended to include different types of tools, active or inactive, such as volumetric analysis sensors, touch probes, 3D range scanners, etc.

### BRIEF DESCRIPTION OF THE DRAWINGS

Having thus generally described the nature of the invention, reference will now be made to the accompanying drawings, showing by way of illustration a preferred embodiment thereof, and in which:

FIG. 1 shows a prior art representation of an ultrasound probe measuring the thickness between the external and internal surfaces of an object;

FIG. 2 depicts a configuration setup of a working environment including an apparatus for three-dimensional inspection in accordance with the present invention;

FIG. 3 illustrates three-dimensional reference features on an object, in accordance with the present invention;

FIG. 4 illustrates an object to be measured, in accordance with the present invention;

FIG. 5 presents an example of a window display for diagnosis inspection, in accordance with the present invention;

FIG. 6 is a flow chart of steps of a method for the inspection of an object, in accordance with the present invention; and

FIG. 7 is a flow chart of steps of a method for automatic leapfrogging, in accordance with the present invention.

It is noted that throughout the drawings, like features are identified by like reference numerals.

### DETAILED DESCRIPTION

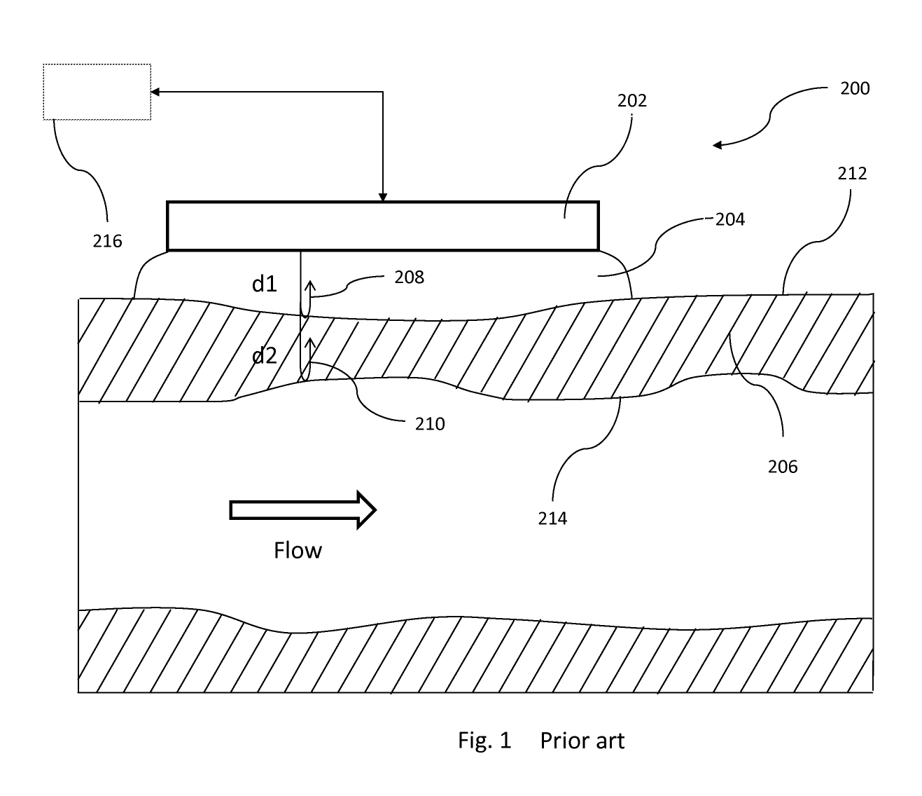

Ultrasonic inspection is a very useful and versatile NDT or NDE method. Some of the advantages of ultrasonic inspection include its sensitivity to both surface and subsurface discontinuities, its superior depth of penetration in materials, and the requirement to only single-sided access when using pulse-echo technique. Referring to FIG. 1, a prior art ultrasound probe measuring the thickness of an object is generally shown at 200. This ultrasound probe is an example of a volumetric analysis sensor. It produces inspection measurements A longitudinal cross-section of the object to be inspected is depicted. Such an object could be a metallic pipe that is inspected for its thickness anomaly due to corrosion (external or internal) or internal flow. In the figure, the sensor head is represented at 202 and the diagnosis machine at 216. While the pipe cross-section is shown at 206, the external surface of the pipe is represented at 212, its internal surface is shown at 214.

The couplant 204 between the sensor transducer and an object is typically water or gel or any substance that improves the transmission of signal between the sensor 202 and the object to be measured. In the case of an ultrasonic probe, one or several signals are emitted from the probe and transmitted through the couplant and object's material before being reflected back to the sensor probe. In this reflection (or pulse-echo) mode, the transducer performs both the sending and the receiving of the pulsed waves as the “sound” is reflected back to the device. Reflected ultrasound comes from an interface, such as the back wall of the object or from an imperfection within the object. The detected reflection constitutes inspection measurements. The measured distance can be obtained after calculating the delay between emission and reception.

While measuring the thickness of a material section, there will typically be two main delayed reflections. It is worth noting that a flaw inside the material could also produce a reflection. Finally, the thickness of the material is obtained after calculating the difference between the two calculated distances d1 and d2 shown at 208 and 210 respectively. Given the position of the sensor in a global reference coordinate system, it is possible to accumulate the thickness ε of the object's material in this global coordinate system:

ε(x, y, z, θ, φ, ω)=d2−d1

An ultrasound probe may contain several measuring elements into a phased array of tens of elements. Integrating the thickness measurements in a common global coordinate system imposes the calculation of the rigid spatial relationship between the volumetric analysis sensor's coordinate system and the measured position and orientation in the coordinate system of the positioning device, namely the external coordinate system of the device. In the described case, this can be measured and calculated using a reference object of known geometry. A cube with three orthogonal faces can be used for that purpose. One then collects measurements on each of the three orthogonal faces while recording the position of the sensor using the positioning device. The 6 parameters (x, y, z, θ, φ, ω) of the 4×4 transformation matrix τ₂ along with the parameters Aᵢ=(aᵢ₁, aᵢ₂, aᵢ₃, aᵢ₄) for each of the three orthogonal planar faces, can be obtained after least squares minimization of the following objective function:

$${min}_{{A}_{i} , {τ}_{2}} {\sum }_{i , j}^{ } {( {A}_{i} {τ}_{1} {τ}_{2} {x}_{ij} )}^{2} w , r , t , ‖ {a}_{i 1} , {a}_{i 2} , {a}_{i 3} ‖ = 1$$

In this equation, xᵢⱼ is the j^{th} measurement collected on the i^{th} planar section; this measurement is a 4D homogeneous coordinate point. Both matrices τ₁ and τ₂ describe a rigid transformation in homogeneous coordinates. Matrix τ₁ corresponds to the rigid transformation provided by the positioning device. These two matrices are of the following form:

$$[ \begin{matrix}{r}_{11} & {r}_{12} & {r}_{13} & tx \\ {r}_{21} & {r}_{22} & {r}_{23} & ty \\ {r}_{31} & {r}_{32} & {r}_{33} & tz \\ 0 & 0 & 0 & 1\end{matrix} ]$$

where the upper left 3×3 submatrix is orthonormal (a rotation matrix) and the upper 3×1 vector is a translation vector.

If one expects to collect measurements while the volumetric analysis sensor is under motion, one must further synchronize the positioning device with the volumetric analysis sensor. This is accomplished using trigger input signal typically from the positioning device but the signal can be external or even come from the volumetric analysis sensor.

This approach is valid as long as the global coordinate system stays rigid with respect to the object. In many circumstances, that could be difficultly ensured. One situation is related to uncontrolled object motion or the converse, which happens when the apparatus measuring the pose of the sensor in the global coordinate system, is itself under motion such as oscillations. The required accuracy is typically better than 1 mm.

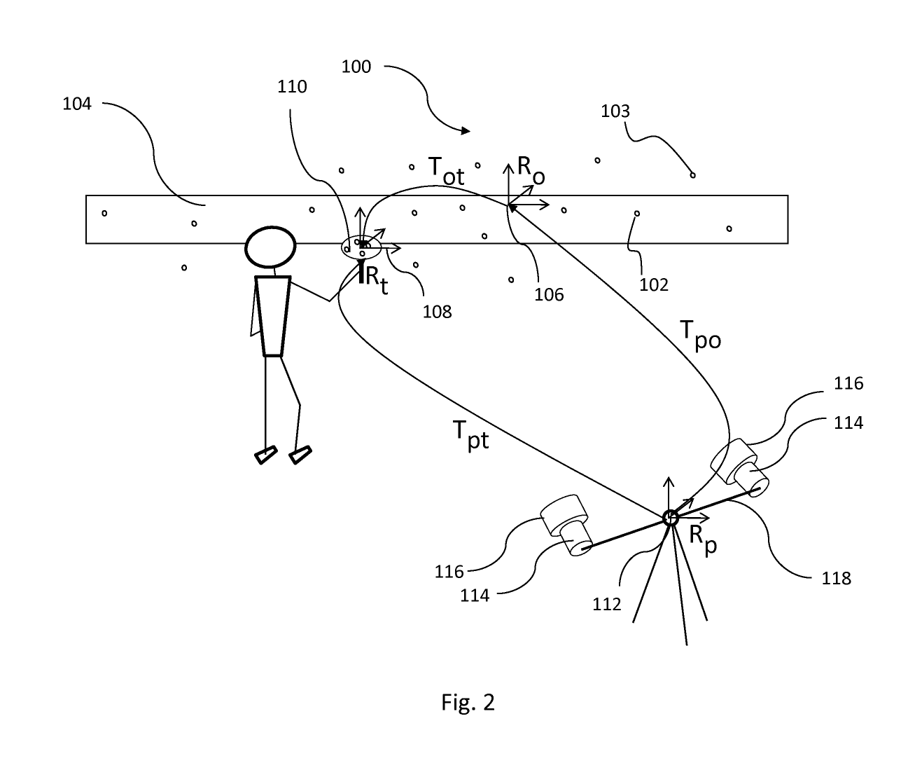

FIG. 2 illustrates the proposed positioning system, shown at 100, to address this problem. In the positioning method, reference targets 102 are affixed to the object, 104, and/or on the surrounding environment as shown at 103. These are object reference targets. A model of the 3D position of these targets is built either beforehand or online using photogrammetric methods that are known to one skilled in the art. This is referred to as the object model of a pattern of 3D positions of at least some of the object reference targets. The photogrammetric system depicted in FIG. 2 at 118 is composed of two cameras, 114, where each camera includes a ring light 116 that is used to illuminate the targets. These targets can be retro-reflective to provide a sharp signal in the images captured by the photogrammetric system within its field of view.

A photogrammetric system with only one camera can also be used.

Furthermore, a ring light need not be used by the photogrammetric system. Indeed, ring lights are useful in the case where the targets are retro-reflective. If the targets are LEDs or if the targets are made of a contrasting material, the photogrammetric system may be able to locate the targets in the image without use of a ring light at the time of image capture by the camera. In the case where ring lights are used, in combination with retro-reflective targets, one will readily understand that the ring light does not need to be completely circular and surrounding the camera. The ring light can be an arrangement of LEDs which directs light substantially co-axially with the line of sight of its camera.

Also shown in FIG. 2, are the three coordinate systems involved in the present method. The first coordinate system is Rₚ 112 which is depicted at the origin of the positioning system based on photogrammetry. The second coordinate system Rₒ at 106, represents the object's coordinate system. Finally, Rₜ 108 is associated with the volumetric analysis sensor 110, such as an ultrasonic sensor. The 6 DOF spatial relationships—Tₚₒ and Tₚₜ illustrated in FIG. 2—between all these coordinate systems can be continuously monitored. It is again worth noting that this configuration can maintain a continuous representation of the spatial relationship between the system and the object. The object spatial relationship is the spatial relationship between the object and the photogrammetric system. In the represented situation in FIG. 2, this spatial relationship is obtained after multiplying the two spatial relationships, Tₚₒ⁻¹ and Tₚₜ, when represented as 4×4 matrices:

Tₒₜ=Tₚₒ⁻¹Tₚₜ

When it is useful to consider independent motion between the object, the system and another structure (fixed or not), it is clear that an additional coordinate system can be maintained. In the figure, for instance, an additional coordinate system could be attached to the reference targets that are affixed on the environment surrounding the object. The environment surrounding the object to be inspected can be another object, a wall, etc. If reference targets are affixed to the surrounding environment of the object, the system can also track that environment.

A sensor-to-object spatial relationship can be determined to track the relationship between the volumetric analysis sensor and the object. The object spatial relationship and the sensor spatial relationship are used to determine the sensor-to-object spatial relationship.

Still in FIG. 2, a set of reference targets are affixed to the volumetric analysis sensor 110. These are the sensor reference targets. A sensor model of a pattern of 3D positions of at least some of the sensor reference targets is provided. This pattern is modeled beforehand as a set of 3D positions, T, which is optionally augmented with normal vectors relative to each reference target. This pre-learned model configuration can be recognized by the positioning system 118 using at least one camera. The positioning system at 118 can thus recognize and track the volumetric analysis sensor and the object independently and simultaneously. A sensor spatial relationship between the photogrammetric system and the sensor reference targets is obtained.

It is also possible to use coded targets either on the object or on the sensor tool. Then, their recognition and differentiation are simplified. When the system 118 is composed of more than one camera, they are synchronized. The electronic shutters are set to capture images within a short exposure period, typically less than 2 milliseconds. Therefore all components of the system, represented in 3D space by their coordinate systems, are positioned relatively at each frame. It is thus not imposed to keep them fixed.

Another advantage of the proposed system is the possibility to apply leapfrogging without requiring the prior art manual procedure. The system with the camera can be moved to observe the scene from a different viewpoint. The system then automatically recalculates its position with respect to the object as long as a portion of the targets visible from the previous viewpoint are still visible in the newly oriented viewpoint. This is performed intrinsically by the system, without any intervention since the pattern of reference targets is recognized.

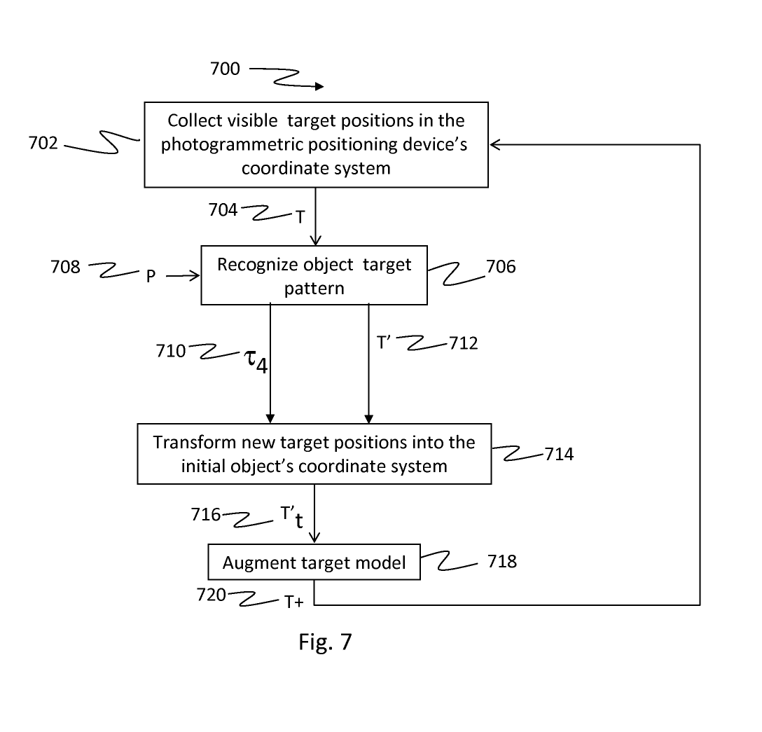

Improved leapfrogging is also possible to extend the section covered by the targets. It is possible to model the whole set of targets on the object, beforehand using photogrammetry or augment the target model online using a prior art method. FIG. 7 is a flow chart 700 of some steps of this improved leapfrogging procedure. The system initially collects the set T, 704, of visible target positions in the photogrammetric positioning device's coordinate system 702. This set of visible targets can be only a portion of the whole set of object reference targets and sensor reference targets, namely those apparent on the image. Then the system recognizes at 706 the set of modeled patterns P at 708, including the object target pattern, and produces as output a set of new visible targets T′ 712 as well as the parameters τ₄, at 710, of the spatial relationship between the object's coordinate system and the photogrammetric positioning device. From the newly observed spatial relationship, the new set of visible targets 712 is transformed into the initial object's coordinate system at 714 before producing T′ₜ, the transformed set of new visible targets shown at 716. Finally, the target model is augmented with the new transformed visible targets, thus producing the augmented set of targets, T+, at 720 in the object's coordinate system.

At this point, it is possible to inspect the surface thickness of an object from several positions and transform these measurements within the same coordinate system. Having the spatial relationship in a single coordinate system, it is also possible to filter noise by averaging measurements collected within a same neighbourhood.

Using the sensor spatial relationship, the object spatial relationship and/or the sensor-to-object spatial relationship, the inspection measurements obtained by the volumetric analysis sensor can be referenced in a common coordinate system and become referenced inspection data.

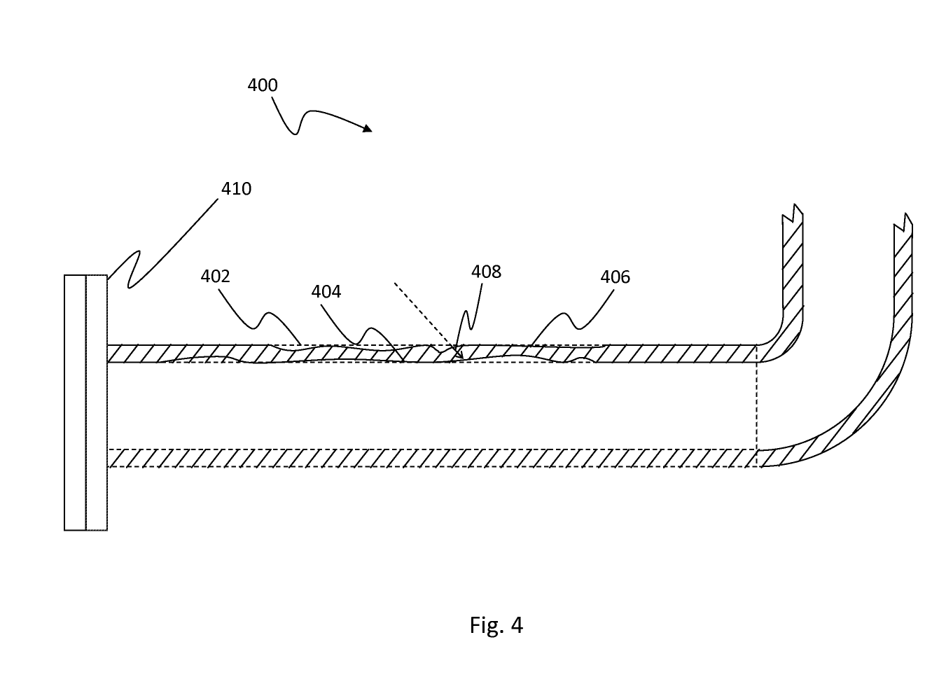

In order to discriminate between internal and external anomalies, the following method is proposed. In FIG. 4, the longitudinal cross-section of a pipe is depicted at 400. The ideal pipe model is shown in dotted line at 402. The external surface is shown at 406 and the internal surface is shown at 404. When anomalies are due to corrosion for instance, it is advantageous to identify whether the altered surface is inside or outside. In this case the reference targets that are affixed to the object may not be sufficient. Additional sensor tools, such as a 3D range scanner that provides a model of the external surface can also be provided in the present system. Although several principles exist for this type of sensor tool, one common principle that is used is optical triangulation. For instance, the scanner illuminates the surface using structured light (laser or non coherent light) and at least one optical sensor such as a camera gathers the reflected light and calculates a set of 3D points by triangulation, using calibration parameters or an implicit model encoded in a look-up table describing the geometric configuration of the cameras and structured light projector. The set of 3D points is referred to as sensor information. These range scanners provide sets of 3D points in a local coordinate system attached to them.

Using a calibration procedure, reference targets can be affixed to the scanner. Therefore, it can also be tracked by the photogrammetric positioning system shown in FIG. 2 at 118. Using a tool model of a pattern of 3D positions of at least some of the tool reference targets affixed to the additional sensor tool, a tool spatial relationship can be determined between the photogrammetric system and the tool reference targets. The 3D point set can be mapped into the same global coordinate system attached in this case to the positioning device and shown here at 112. It is further possible to reconstruct a continuous surface model of the object from the set of 3D points. Finally, one can exploit the spatial relationship between the coordinate system of the positioning device and the object's coordinate system in order to transform the surface model into the object's coordinate system. In this case, the object's coordinate system will remain the true fixed global or common coordinate system. The tool-to-object spatial relationship being obtained from the tool spatial relationship and the sensor-to-object and/or object spatial relationships.

A model of the object's external surface is obtained along with a set of thickness measurements along directions that are stored within the same global coordinate system. From the external surface model, Sₑ(u,v)={x,y,z}, the thickness measurement is first converted into a vector V that is added to the surface point before obtaining a point on the internal surface Sᵢ, shown at 408 in FIG. 4. Therefore, it is possible to recover the profile of the internal surface. Typically, using ultrasound, the precision of this internal surface model is less than the precision reached for the external surface model. It is thus an option either to provide a measurement of thickness attached to the external surface model or to provide both surface models, internal and external, in registration, meaning in alignment in the same coordinate system.

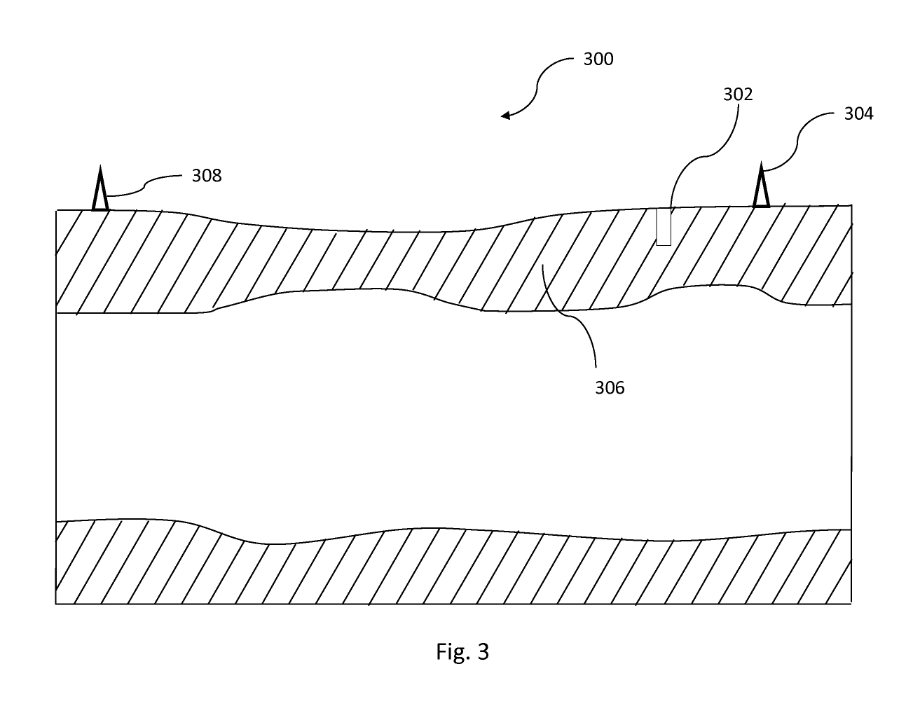

In order to complete surface inspection, the external surface model is registered with a computer aided design (CAD) model of the object's external surface. When this latter model is smooth or includes straight sections, the quality of alignment is highly reliable. That registration may require the scanning of features such as the flange shown at 410 in FIG. 4 to constrain the 6 DOF of the geometric transformation between the CAD model and the scanned surface. In some situations, physical features such as drilled holes or geometric entities on the object will be used as explicit references on the object. Examples are shown at 302, 304 and 308 in the drawing 300 depicted in FIG. 3. In this figure, the object is shown at 306. These specific features might be better measured using a touch probe than a 3D optical surface scanner, namely a range scanner. The touch probe is another type of additional sensor tool. It is also possible to measure the former type of features, like the flange, with the touch probe. A touch probe is basically constituted of a solid small sphere that is referenced in the local coordinate system of the probe. Using the positioning system shown at 118 in FIG. 2, a pattern of reference targets (coded or not) is simply fixed to a rigid part on which the measuring sphere is mounted. This probe is also positioned by the system. Finally an inspection report can be provided where both internal and external local anomalies are quantified. In the case of corrosion analysis, internal erosion is decoupled from external corrosion.

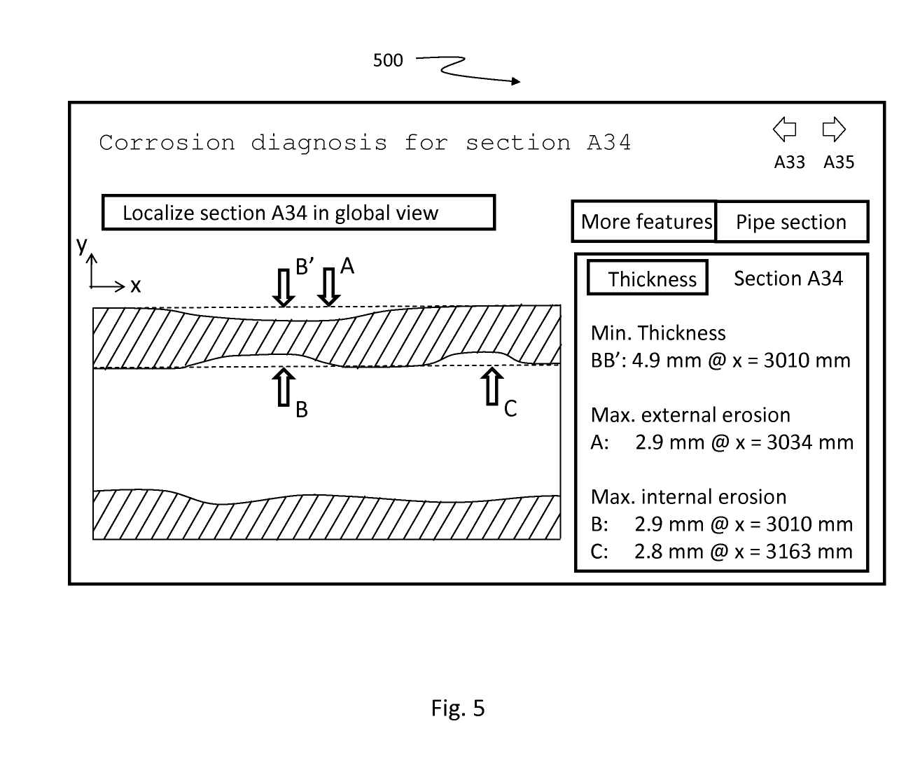

An example of such a partial diagnosis is shown at 500 in FIG. 5. Generated referenced object inspection data is shown. The inspection data numerically shown on the right hand side of the display is positioned on the section of the object using the arrows and the letters to correlate the inspection data to a specific location on the object.

The positioning system makes it possible to use one, two, three or even more sensor tools. For example, the volumetric analysis sensor can be a thickness sensor that is seamlessly used with the 3D range scanner and a touch probe. Through the user interface, the user can indicate when the sensor tool is added or changed. Another optional approach is to let the photogrammetric positioning system recognize the sensor tool based on the reference targets, coded or not, when a specific pattern for the location of the reference targets on the sensor tool is used.

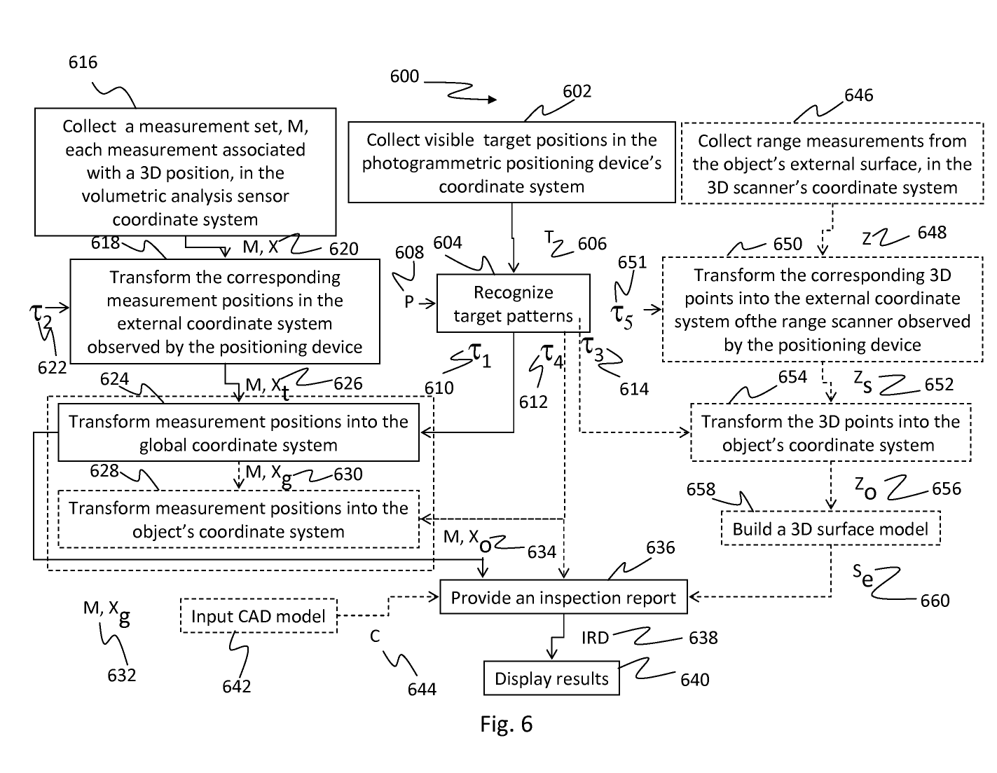

FIG. 6 illustrates the main steps of the inspection method 600. A position tracker is used as part of the positioning system and method to obtain the models of reference targets and to determine the spatial relationships. This position tracker can be provided as part of the photogrammetric system or independently. It can be a processing unit made of a combination of hardware and software components which communicates with the photogrammetric system and the volumetric analysis sensor to obtain the required data for the positioning system and method. It is adapted to carry out the steps of FIG. 6 in combination with other components of the system, for example with a model builder which builds sensor, object or tool models using the photogrammetric system.

A set of visible target positions, T at 606, is collected in the photogrammetric positioning device's coordinate system 602. The set P of modeled target patterns composed of the previously observed object targets and patterns attached to several sensor tools is provided at 608. The system then recognizes these patterns 604 and produces the parameters τ₁ at 610, of the spatial relationships between the positioning device and each of the volumetric analysis sensors, if more than one. In this case, the global coordinate system is attached to the positioning device. Optionally, the parameters τ₄ at 612, of the spatial relationships between the positioning device and/or the object and the parameters τ₃ at 614, of the spatial relationships between the positioning device and a surface range scanner are also provided.

Still referring to FIG. 6, a volumetric analysis sensor set, M and a set of 3D corresponding positions X, both shown at 620, are collected at 616 before transforming these positions X into the external coordinate system observed by the positioning device at 618. The external coordinate system is observable by the positioning device as opposed to its internal coordinate system. The parameters τ₂ at 622, of the rigid transformation between these two coordinate systems are obtained after calibration. After this operation, the volumetric analysis sensor set is mapped to positions in the external coordinate system of the volumetric analysis sensor, leading to M, Xₜ at 626. Then, using the parameters τ₁ provided by the positioning device, the positions Xₜ are transformed into the global coordinate system corresponding to the positioning device at 624. The resulting positions are shown at 630. These same measurements and position, shown at 632, can be directly used as input for the final inspection. When the coordinate system attached to the targets affixed to the object is measured, the position Xₜ can be further transformed into the object's coordinate system at 628, using the parameters τ₄, thus leading to the set of positions Xₒ at 634, in the object's coordinate system. It is clear that these two steps at 624 and 628 can be combined into a single step.

In the same figure, an inspection report is provided at 636. This report can either accumulate the volumetric analysis sensor measurements within at least a single coordinate system, optionally compare these measurements with an input CAD model shown at 642 and transferred as C at 644. The input CAD model can be aligned based on the measurement of features obtained with a touch probe or extracted from a surface model S shown at 660, measured using a 3D surface range scanner. In some applications, such as pipe inspection, the CAD model can be used only for providing a spatial reference to the inspected section. Actually, although positioning features are present, it is possible that the ideal shape be deformed while one is only interested in assessing the local thickness of a corroded pipe section. A surface model can be continuous or provided as a point cloud. Interestingly, the 3D range scanner collects range measurements from the object's external surface at 646, and then one transforms the measured surface points Z shown at 648, into the external coordinate system of the range scanner observed by the positioning device at 650. To do so, the parameters of the rigid transformations between the internal coordinate system of the 3D range scanner and its external coordinate system that is observable by the positioning device, are utilized. These parameters τ₅ at 651 are pre-calibrated. The transformed 3D surface points Zₛ at 652 are then transformed into the object's coordinate system at 654 using the parameters τ₃ at 614 of the rigid transformation between the positioning device and the external coordinate system of the 3D range scanner. The resulting point set Zₒ is used as input in order to build at 658 a 3D surface model S. Although this is the scenario of the preferred embodiment, it is clear that a 3D range scanner could exploit the positioning targets or any other available means for accumulating the 3D point sets in a single coordinate system and then one could map these points to the object's coordinate system determined by the positioning device, only at the end. In this scenario, the 3D range scanner need not be continuously tracked by the positioning device.

Improved leapfrogging, shown at 700 in FIG. 7, will improve block 602 in FIG. 6 by making it possible to displace the positioning device without any manual intervention. The leapfrogging technique can also compensate for any uncontrolled motion of the object, the volumetric analysis sensor or even the photogrammetric system. Such uncontrolled motion could be caused by vibrations, for example. After collecting the visible target positions in the positioning device's coordinate system at 702, the set of target positions T at 704, is provided as input for recognizing the object pattern at 706. To do so, a model P 708 of each of the target patterns for the sensor tools as well as for the objects seen in previous frames, is input. The set of newly observed targets T′ at 712 along with the parameters τ₄ at 710 and at 612 of the rigid transformation between the object's pattern and the positioning device are calculated. The set T′ can then be transformed into the initial object's coordinate system at 714, thus leading to the transformed target positions T′ₜ at 716. The initial target model is finally augmented at 718 to T+ 720, the augmented object target model.

Measuring thickness is only one property that can be measured in registration with the surface model and eventually object features. It is clear that other types of measurements can be inspected in registration with the object's surface or features, using the same method. Actually, the method naturally extends to other types of measurements when the volumetric analysis sensor can be positioned by the photogrammetric positioning system. For instance, one can use an infrared sensor, mounted with targets, and inspect the internal volume of objects for defects based on the internal temperature profile after stimulation. This type of inspection is commonly applied to composite materials. For instance, inspecting the internal structure of composite parts is a practice in the aeronautic industry where wing sections must be inspected for the detection of lamination flaws. The method described herein, will make it possible to precisely register a complete set of measurements all over the object or optionally, small sporadic local samples with the external surface of small or even large objects.

X-ray is another example of a modality that can be used to measure volumetric properties while being used as a sensor tool in the system.

It is therefore possible to determine whether surface erosion affects more the internal surface compared with the external surface, and more precisely in what proportion. Indeed, one can measure and combine, within the same coordinate system, a continuous model of the external surface in its current state and the thickness measurements gathered over the surface at different positions and orientations of the sensor and determine the erosion status.

It is therefore possible to add a dense and accurate model of an external surface as a reference which would definitely be an advantage that would enhance quantitative NDE analyses. A complete analysis can be performed using several devices instead of a single multi-purpose with too many compromises. The solution can thus provide a simple way to collect transform all types of measurements, including the external surface geometry, within the same global coordinate system.

While illustrated in the block diagrams as groups of discrete components communicating with each other via distinct data signal connections, it will be understood by those skilled in the art that the embodiments can be provided by combinations of hardware and software components, with some components being implemented by a given function or operation of a hardware or software system, and many of the data paths illustrated being implemented by data communication within a computer application or operating system or can be communicatively linked using any suitable known or after-developed wired and/or wireless methods and devices. Sensors, processors and other devices can be co-located or remote from one or more of each other. The structure illustrated is thus provided for efficiency of teaching the example embodiments.

It will be understood that numerous modifications thereto will appear to those skilled in the art. Accordingly, the above description and accompanying drawings should be taken as illustrative of the invention and not in a limiting sense. It will further be understood that it is intended to cover any variations, uses, or adaptations of the invention following, in general, the principles of the invention and including such departures from the present disclosure as come within known or customary practice within the art to which the invention pertains and as may be applied to the essential features herein before set forth, and as follows in the scope of the appended claims.

1. A positioning method for non-destructive inspection of an object, comprising:
providing at least one volumetric analysis sensor for said inspection, said volumetric analysis sensor having sensor reference targets;
providing a sensor model of a pattern of 3D positions of at least some of said sensor reference targets of said volumetric analysis sensor;
providing object reference targets on at least one of said object and an environment of said object;
providing an object model of a pattern of 3D positions of at least some of said object reference targets;
providing a photogrammetric system including at least one camera to capture at least one image in a field of view;
capturing an image in said field of view using said photogrammetric system, at least a portion of said sensor reference targets and said object reference targets being apparent on said image;
determining a sensor spatial relationship between the photogrammetric system and said sensor reference targets using said sensor model and said captured image;
determining an object spatial relationship between the photogrammetric system and said object reference targets using said object model and said captured image;
determining a sensor-to-object spatial relationship of said at least one volumetric analysis sensor with respect to said object using said object spatial relationship and said sensor spatial relationship;
repeating said capturing, said determining said sensor-to-object spatial relationship and at least one of said determining said sensor spatial relationship and said determining said object spatial relationship;
tracking a displacement of said at least one of said volumetric analysis sensor and said object using said sensor-to-object spatial relationship.

2. The positioning method as claimed in claim 1, further comprising providing inspection measurements about said object using said at least one volumetric analysis sensor; and using at least one of said sensor spatial relationship, said object spatial relationship and said sensor-to-object spatial relationship to reference said inspection measurements and generate referenced inspection data in a common coordinate system.

3. The positioning method as claimed in claim 1, wherein at least one of said providing said object model and providing said sensor model includes building a respective one of said object and sensor model during said capturing said image using said photogrammetric system.

4. The positioning method as claimed in claim 1, further comprising:
providing an additional sensor tool;
obtaining sensor information using said additional sensor tool;
referencing said additional sensor tool with respect to said object.

5. The positioning method as claimed in claim 4, wherein said referencing said additional sensor tool with respect to said object includes using an independent positioning system for said additional sensor tool and using said object reference targets.

6. The positioning method as claimed in claim 4,
wherein said additional sensor tool has tool reference targets;
further comprising:
providing a tool model of a pattern of 3D positions of at least some of said tool reference targets of said additional sensor tool;
determining a tool spatial relationship between the photogrammetric system and said tool reference targets using said tool model;
determining a tool-to-object spatial relationship of said additional sensor tool with respect to said object using said tool spatial relationship and at least one of said sensor-to-object spatial relationship and said object spatial relationship;
repeating said capturing, said determining said tool spatial relationship and said determining said tool-to-object spatial relationship;
tracking a displacement of said additional sensor tool using said tool-to-object spatial relationship.

7. The positioning method as claimed in claim 2, further comprising building a model of an internal surface of said object using said inspection measurements obtained by said volumetric analysis sensor.

8. The positioning method as claimed in claim 2, wherein said inspection measurements are thickness data.

9. The positioning method as claimed in claim 2, further comprising
providing a CAD model of an external surface of said object;
using said CAD model and said sensor-to-object spatial relationship to align said inspection measurements obtained by said volumetric analysis sensor in said common coordinate system.

10. The positioning method as claimed in claim 4, further comprising
providing a CAD model of an external surface of said object;
acquiring information about features of said external surface of said object using said additional sensor tool;
using said CAD model, said information about features and said sensor-to-object spatial relationship to align said inspection measurements obtained by said volumetric analysis sensor in said common coordinate system.

11. A positioning system for non-destructive inspection of an object, comprising:
at least one volumetric analysis sensor for said inspection, said volumetric analysis sensor having sensor reference targets and being adapted to be displaced;
object reference targets provided on at least one of said object and an environment of said object;
a photogrammetric system including at least one camera to capture at least one image in a field of view, at least a portion of said sensor reference targets and said object reference targets being apparent on said image;
a position tracker for
obtaining a sensor model of a pattern of 3D positions of at least some of said sensor reference targets of said volumetric analysis sensor;
obtaining an object model of a pattern of 3D positions of at least some of said object reference targets;
determining an object spatial relationship between the photogrammetric system and said object reference targets using said object model pattern and said captured image;
determining a sensor spatial relationship between the photogrammetric system and said sensor reference targets using said sensor model and said captured image;
determining a sensor-to-object spatial relationship of said at least one volumetric analysis sensor with respect to said object using said object spatial relationship and said sensor spatial relationship;
tracking a displacement of said volumetric analysis sensor using sensor-to-object spatial relationship.

12. The positioning system as claimed in claim 11, wherein said volumetric analysis sensor provides inspection measurements about said object and wherein said position tracker is further for using at least one of said sensor spatial relationship, object spatial relationship and sensor-to-object spatial relationship to reference said inspection measurements and generate referenced inspection data.

13. The positioning system as claimed in claim 12, further comprising a model builder for building at least one of said sensor model and said object model using said photogrammetric system.

14. The positioning system as claimed in claim 11, further comprising an additional sensor tool for obtaining sensor information.

15. The positioning system as claimed in claim 14, wherein said additional sensor tool is adapted to be displaced and said additional sensor tool has tool reference targets and wherein said position tracker is further for tracking a displacement of said additional sensor tool using said photogrammetric system and a tool model of a pattern of tool reference targets on said additional sensor tool.
